(19) United States
(12) Patent Application Publication
(10) Pub. No.: US 2024/0121681 A1
(43) Pub. Date: Apr. 11, 2024

(54) WIRELESS TELECOMMUNICATIONS NETWORK

(71) Applicant: BRITISH TELECOMMUNICATIONS PUBLIC LIMITED COMPANY, London (GB)

(72) Inventors: Salvador DIAZ SENDRA, London (GB); Sabanayagam HESWARAN, London (GB)

(21) Appl. No.: 18/551,710

(22) PCT Filed: Feb. 14, 2022
(86) PCT No.: PCT/EP2022/053540

§ 371 Date: Sep. 21, 2023

(30) Foreign Application Priority Data
Mar. 23, 2021 (GB) 2104001.9

(51) Int. Cl. H04W 36/00; H04W 24/10

(52) U.S. Cl. CPC H04W 36/0088; H04W 24/10

(57) ABSTRACT

This disclosure provides a method of operating a User Equipment (UE) in a wireless telecommunications network, the wireless telecommunications network including a first access point, a second access point and a third access point, wherein the UE is connected to the first access point and the second and third access points communicate based on periodic time frames

### PRIORITY CLAIM

The present application is a National Phase entry of PCT Application No. PCT/EP2022/053540, filed Feb. 14, 2022, which claims priority from GB Patent Application No. 2104001.9, filed Mar. 23, 2021, each of which is hereby fully incorporated herein by reference.

### TECHNICAL FIELD

The present disclosure relates to a wireless telecommunications network.

### BACKGROUND

User Equipment (UE) in wireless telecommunications networks, such as cellular telecommunications network, are typically configured so as to communicate with one or more serving access points. The UE may also need to communicate with one or more other access points that are not serving the UE. This may be required when the UE is identifying candidate target access points that may serve the UE in the future. If the UE and other access point are not using the same frequency and/or radio access technology, then the UE needs to reconfigure to the respective frequency and/or radio access technology in order to communicate with that other access point. In order to communicate with the other access point when such reconfiguration is required, the UE must temporarily suspend its communications with its one or more serving access points. Once the UE has completed its communications with the other access point, it may reconfigure to its original configuration so as to resume communications with the one or more serving base stations.

A time period during which the UE suspends its communications with its one or more serving access points is known as the measurement gap. The length of the measurement gap is known as the Measurement Gap Length (MGL). In Long Term Evolution (LTE), as defined by the 3 rd Generation Partnership Project (3GPP), the MGL is 6 ms. In New Radio (NR), again as defined by 3GPP, the MGL is one of 1.5 ms, 3 ms, 3.5 ms, 4 ms, 5.5 ms and 6 ms. The measurement gap occurs within each time frame of a sequence of time frames. The length of each time frame is known as the Measurement Gap Repetition Period (MGRP) and the time difference between the start of each time frame and the start of the measurement gap is known as the gap offset. In LTE, the MGRP may be 40 ms or 80 ms. In NR, the MGRP may be 20 ms, 40 ms, 80 ms or 160 ms. The gap offset may be any value between 0 ms and MGRP-1 ms. The serving access point configures the MGL, MGRP and gap offset of the UE.

A problem exists in that the serving access point and the other access point need to be time synchronized for the UE to communicate with the other access point. That is, if the serving access point and other access point are not time synchronized, then the measurement gap (as configured by the serving access point) may not coincide with the attempted communication between the UE and other access point (such as a Synchronization Signal Block (SSB) transmitted by the other access point to the UE). In other words, the communication between the UE and other access point may occur at a different time to the measurement gap. FIG. 1 is a schematic diagram of a sequence of time frames for a UE, in which the serving access point has configured the UE to use an MGL of 6 ms, a MGRP of 40 ms and a gap offset of 0 ms. This figure shows that the other access point, having an SSB transmission (shown using hashed lines) of duration 2 ms and periodicity 20 ms, does not fall within the measurement gap of any time frame. As a result, the UE will never detect the SSB of the other access point.

There are many scenarios where it is undesirable for the UE to be unable to communicate with another access point, such as when the other access point could have become a secondary access point in a dual connectivity scenario (such as the addition of a NR access point as a secondary access point in an Evolved-Universal Terrestrial Radio Access-New Radio Dual Connectivity (EN-DC) scenario or the addition of a NR access point as a secondary access point in a NR Dual Connectivity (NR-DC) scenario), or when the other access point could have been a target access point in a handover (such as when a UE is being handed over from a serving NR Frequency Division Duplex (FDD) access point to a target NR FDD access point, handed over in an EN-DC scenario, handed over in a NR-Evolved-Universal Terrestrial Radio Access Dual Connectivity (NE-DC) scenario, handed over in a Multi-Radio Access Technology Dual Connectivity (MR-DC) scenario, or handed over in a NR-DC scenario).

One solution to this problem is to enforce time synchronization between the UE, serving access point and other access point. However, there is a corresponding hardware cost (such as the cost of a Global Positioning System (GPS) module that can provide an accurate time reference) with this solution.

### SUMMARY

According to a first aspect of the disclosure, there is provided a method of operating a User Equipment, UE, in a wireless telecommunications network, the wireless telecommunications network including a first access point, a second access point and a third access point, wherein the UE is connected to the first access point and the second and third access points communicate based on periodic time frames, the method comprising receiving a first configuration message from the first access point, the first configuration message including measurement gap configuration data; configuring a first measurement gap having a first set of measurement gap parameters based on the measurement gap configuration data of the first configuration message; configuring a second measurement gap having a second set of measurement gap parameters based on the measurement gap configuration data of the first configuration message, wherein the first set of measurement gap parameters differs to the second set of measurement gap parameters such that the first and second measurement gaps cover different portions of the second access point's periodic time frame and different portions of the third access point's periodic time frame; receiving a transmission from the second access point in the first measurement gap; receiving an identifier for the second access point; receiving a transmission from the third access point in the second measurement gap; receiving an identifier for the third access point; and following receipt of the transmissions from the second and third access points and of the identifiers of the second and third access points, sending a report message to the first access point, the report message including a first association between the identifier for the second access point and an identifier for the first measurement gap and a second association between the identifier for the third access point and the identifier for the second measurement gap.

The second access point's periodic time frame may include a transmission portion and the first measurement gap covers the transmission portion of the second access point's periodic time frame, the third access point's periodic time frame includes a transmission portion and the second measurement gap covers the transmission portion of the third access point's periodic time frame, and the method may further comprise receiving a second configuration message from the first access point, the second configuration message including measurement gap configuration data; configuring a third measurement gap having a third set of measurement gap parameters based on the measurement gap configuration data of the second configuration message, wherein the third measurement gap covers the transmission portion of the second access point's periodic time frame; and configuring a fourth measurement gap having a fourth set of measurement gap parameters based on the measurement gap configuration data of the second configuration message, wherein the fourth measurement gap covers the transmission portion of the third access point's periodic time frame.

The first set of measurement gap parameters may differ from the second set of measurement gap parameters by having different gap offset values.

The first and second measurement gaps may be of a series of measurement gaps, and each measurement gap of the series of measurement gaps may occur within a respective time frame of a series of time frames, and each time frame of the series of time frames may have a predetermined length, and the method may further comprise configuring each measurement gap of the series of measurement gaps to cover a particular portion of its respective time frame of the series of time frames, wherein a combination of all portions covered by all measurement gaps of the series of measurement gaps relative to their respective time frames covers the predetermined length.

According to a second aspect of the disclosure, there is provided a method of operating a User Equipment, UE, in a wireless telecommunications network, the wireless telecommunications network including a first access point, a second access point and a third access point, wherein the UE is in a coverage area of the first access point, a coverage area of the second access point, and a coverage area of the third access point, the UE is connected to the first access point, the second access point communicates based on a periodic time frame having a transmission portion and the third access point communicates based on a periodic time frame having a transmission portion, the method comprising sending a report message to the first access point, the report message indicating the UE's presence in the second access point's coverage area and the third access point's coverage area; receiving a first configuration message from the first access point in response to the report message, the first configuration message including measurement gap configuration data for the second access point and measurement gap configuration data for the third access point; and configuring a first measurement gap having a first set of measurement gap parameters based on the measurement gap configuration data for the second access point of the first configuration message, wherein the measurement gap covers the transmission portion of the second access point's periodic time frame; and configuring a second measurement gap having a second set of measurement gap parameters based on the measurement gap configuration data for the third access point of the first configuration message, wherein the measurement gap covers the transmission portion of the third access point's periodic time frame.

According to a third aspect of the disclosure, there is provided a method of operating a first access point in a wireless telecommunications network, the wireless telecommunications network including a first User Equipment, UE, a second access point and a third access point, wherein the second access point communicates based on a periodic time frame having a transmission portion and the third access point communicates based on a periodic time frame having a transmission portion, the method comprising sending a first configuration message to the first UE, the first configuration message including measurement gap configuration data to cause the first UE to use a first measurement gap having a first set of measurement gap parameters and to cause the first UE to use a second measurement gap having a second set of measurement gap parameters, wherein the first set of measurement gap parameters differs to the second set of measurement gap parameters such that the first and second measurement gaps cover different portions of the second access point's periodic time frame and different portions of the third access point's periodic time frame; receiving a first report message from the first UE, the first report message including a first association between an identifier for the second access point and an identifier for the first measurement gap and a second association between an identifier for the third access point and an identifier for the second measurement gap; and sending a second configuration message to the first UE, the second configuration message including measurement gap configuration data to cause the first UE to use a third measurement gap having a third set of measurement gap parameters and a fourth measurement gap having a fourth set of measurement gap parameters, wherein the third measurement gap covers the transmission portion of the second access point's periodic time frame and the fourth measurement gap covers the transmission portion of the third access point's periodic time frame.

The wireless telecommunications network may include a second UE, and the method may further comprise receiving a second report message from the second UE, the second report message from the second UE indicating the second UE's presence in the second access point's coverage area; and sending a third configuration message to the second UE, the third configuration message including measurement gap configuration data to cause the second UE to use the third measurement gap having the third set of measurement gap parameters.

According to a fourth aspect of the disclosure, there is provided a computer program comprising instructions which, when the program is executed by a computer, cause the computer to carry out the first, second or third aspects of the disclosure. The computer program may be stored on a computer readable carrier medium.

According to a fifth aspect of the disclosure, there is provided a User Equipment, UE, for a wireless telecommunications network, the UE comprising a transceiver, memory and a processor configured to cooperate to carry out the first or second aspects of the disclosure.

According to a sixth aspect of the disclosure, there is provided an access point for a wireless telecommunications network, the access point comprising a transceiver, memory and a processor configured to cooperate to carry out the third aspect of the disclosure.

### BRIEF DESCRIPTION OF THE FIGURES

In order that the present disclosure may be better understood, embodiments thereof will now be described, by way of example only, with reference to the accompanying drawings in which:

FIG. 1 illustrates a series of time frames of a UE of a conventional approach.

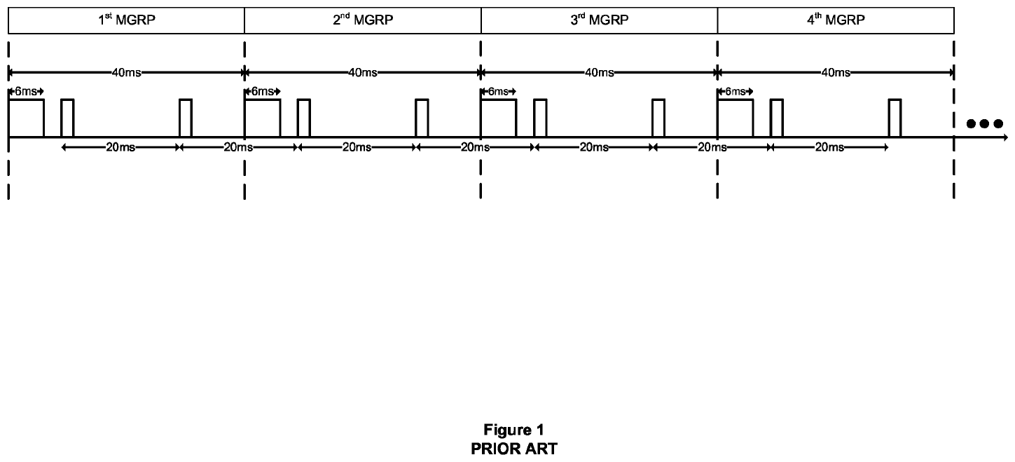

FIG. 2 is a schematic diagram of a cellular telecommunications network of a first embodiment of the present disclosure.

FIG. 3 illustrates a series of time frames of a first UE of the network of FIG. 2.

FIG. 4 is a flow diagram of a first process of an embodiment of a method of the present disclosure, as implemented by the first UE of the network of FIG. 2.

FIG. 5 is a flow diagram of a second process of the embodiment of the method of the present disclosure, as implemented by a serving base station of the network of FIG. 2.

FIG. 6 illustrates a series of time frames of the first UE of the network of FIG. 2 implemented the method of FIG. 4.

### DETAILED DESCRIPTION OF EMBODIMENTS

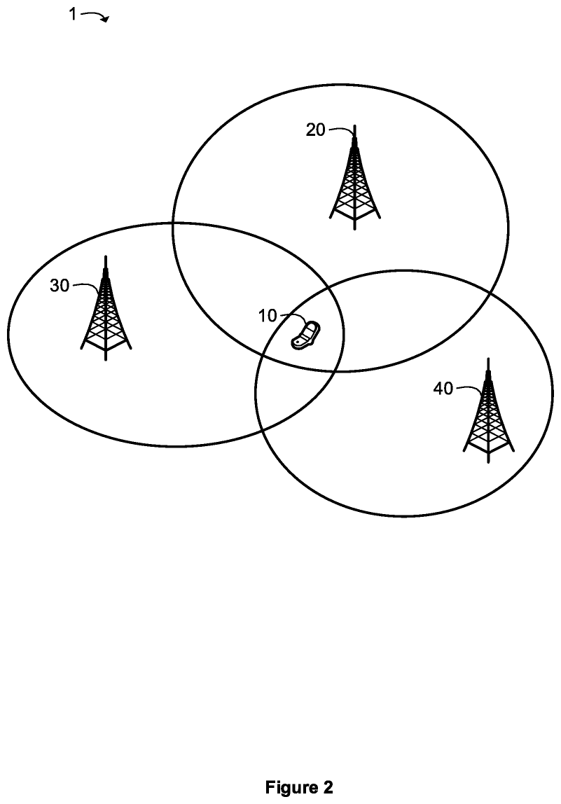

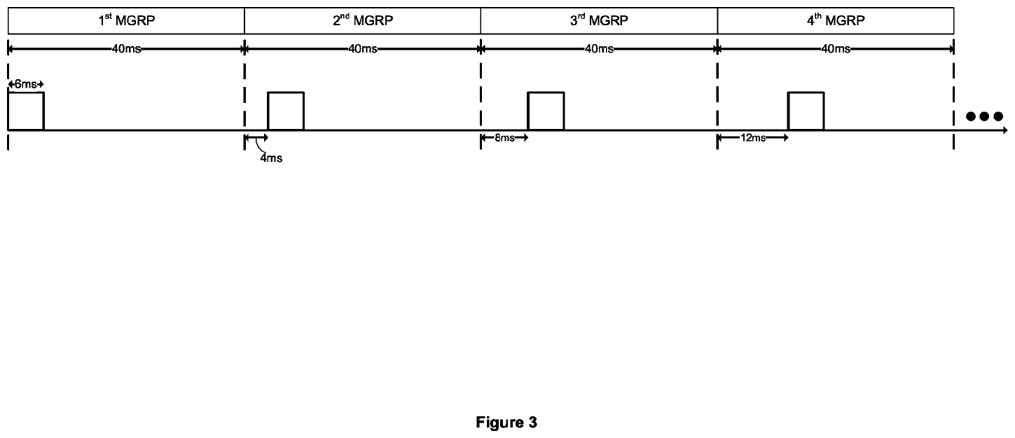

A first embodiment of a cellular telecommunications network 1 the present disclosure will now be described with reference to FIGS. 2 to 3. As shown in FIG. 2, the cellular telecommunications network 1 includes a first User Equipment (UE) 10, a serving base station 20, a first target base station 30 and a second target base station 40. The first UE 10 is connected to the serving base station 20 and communicates with the serving base station using a Frequency Division Duplex (FDD) New Radio (NR) cellular telecommunications protocol as defined by the 3 rd Generation Partnership Project (3GPP). The first and second target base stations 30, 40 are also configured for BUD NR communications. The first UE 10 is one of a plurality of UE (in which only the first UE 10 is shown in FIG. 2), all being served by the serving base station 20.

FIG. 2 also illustrates a coverage area of the serving base station 20, a coverage area of the first target base station 30 and a coverage area of the second target base station 40. The first UE 10 is positioned in an overlapping portion of the respective coverage areas of the serving base station 20, first target base station 30 and second target base station 40, such that the first UE 10 may be handed over from the serving base station 20 to either of the first or second target base station 30, 40.

In this embodiment, the first UE 10 periodically suspends communications with the serving base station 20 in order to perform measurements of other base stations, such as the first target base station 30 and second target base station 40. A time period during which the first UE 10 suspends its communications with the serving base station 20 is the measurement gap. The length of the measurement gap is known as the Measurement Gap Length (MGL) and is configured by the serving base station 20. In this example, the first UE 10 is configured with a 6 ms MGL. The serving base station 20 configures the first UE 10 to communicate based on a series of time frames in which each time frame includes a single measurement gap and each time frame is of a length equal to the Measurement Gap Repetition Period (MGRP). The MGRP is defined by the serving base station 20 and, in this example, is 40 ms. The time difference between the start of a time frame and the measurement gap is the gap offset, which is again defined by the serving base station 20 and may take any value between 0 ms and MGRP-1 ms.

In this embodiment, the serving base station 20 implements a gap offset that may be static or variable. In conventional approaches, the gap offset is the same for all time frames of the series of time frames until the gap offset is reconfigured. However, in this embodiment, the gap offset of a first time frame of the series of time frames may differ to the gap offset of a second time frame of the series of time frames without reconfiguration by the serving base station 20. In this embodiment, the gap offset is implemented such that the gap offset of each time frame of the series of time frames is incremented by a particular time shift value relative to the gap offset of the immediately-preceding time frame in the series of time frames. In other words, the gap offset is implemented such that there is a time period, equal to the length of the MGRP plus the time shift value, between the start of the measurement gap in time frame n in the series of time frames and the start of the measurement gap in time frame n+1 in the series of time frames (in contrast to a static gap offset where the time period between the start of the measurement gap in time frame n in the series of time frames and the start of the measurement gap in time frame n+1 in the series of time frames is equal to the MGRP). The time shift value is an integer in a first set of 0 ms up to the MGL, or any odd integer in a second set of the MGL+1 ms to the MGRP (this second set ensures that, over a series of time frames, the measurement gap covers the entirety of the MGRP). A time shift value of 0 ms is selectable to ensure backwards compatibility with the prior art. In this embodiment, the serving base station 20 configures the UE 10 with a time shift value of 4 ms.

FIG. 3 illustrates a series of time frames for the first UE 10 in which the gap offset is incremented by a time shift value of 4 ms in each successive time frame of a series of time frames. FIG. 3 illustrates four time frames of a series of time frames (i.e. a first time frame, a second time frame immediately succeeding the first time frame, a third time frame immediately succeeding the second time frame, and a fourth time frame immediately succeeding the third time frame). In the first time frame, the gap offset is 0 ms such that the start of the measurement gap occurs at the same time instance as the start of the first time frame. The measurement gap of the first time frame therefore occurs between 0 ms and 6 ms after the start of the first time frame. In the second time frame, the gap offset is incremented by the time shift value (4 ms) relative to the gap offset of the first time period, such that the start of the measurement gap of the second time frame occurs 4 ms after the start of the second time frame. In other words, the start of the measurement gap of the second time frame occurs a time period after the start of the measurement gap of the first time frame equal to the MGRP plus the time shift value (i.e. 40 ms+4 ms). The measurement gap of the second time frame therefore occurs between 4 ms and 10 ms after the start of the second time frame. In the third time frame, the gap offset is incremented by the time shift value (4 ms) relative to the gap offset of the second time period, such that the start of the measurement gap of the third time frame occurs 8 ms after the start of the third time frame. In other words, the start of the measurement gap of the third time frame occurs a time period after the start of the measurement gap of the second time frame equal to the MGRP plus the time shift value (i.e. 40 ms+4 ms). The measurement gap of the third time frame therefore occurs between 8 ms and 14 ms after the start of the third time frame. In the fourth time frame, the gap offset is incremented by the time shift value (4 ms) relative to the gap offset of the third time period, such that the start of the measurement gap occurs 12 ms after the start of the fourth time frame. In other words, the start of the measurement gap of the fourth time frame occurs a time period after the start of the measurement gap of the third time frame equal to the MGRP plus the time shift value (i.e. 40 ms+4 ms). The measurement gap of the fourth time frame therefore occurs between 12 ms and 18 ms after the start of the fourth time frame.

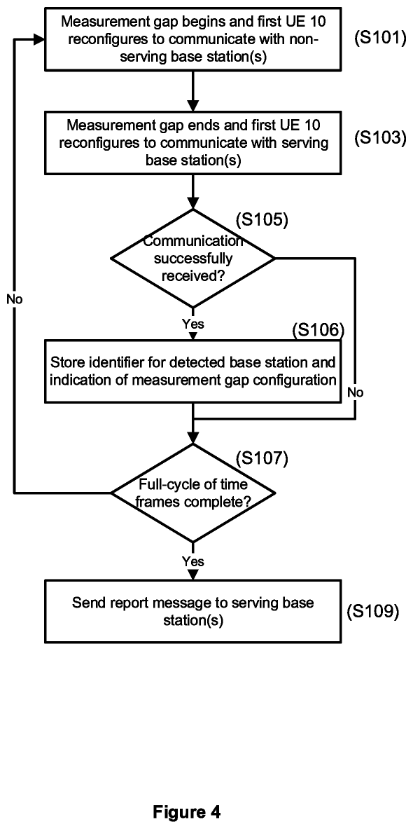

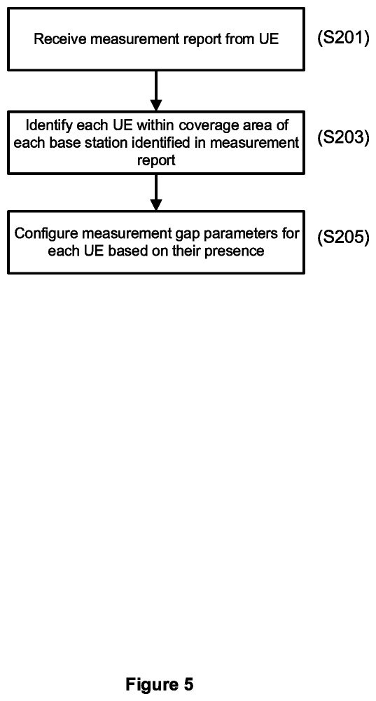

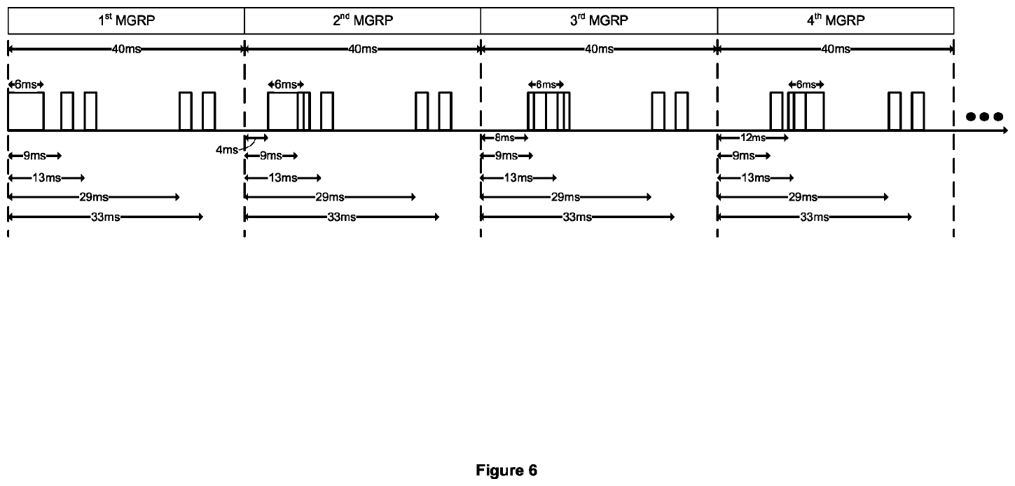

A first embodiment of a method of the present disclosure will now be described with reference to FIGS. 4, 5 and 6. FIG. 4 is a flow diagram of operations implemented by the first UE 10 in the first embodiment of the method of the present disclosure, FIG. 5 is a flow diagram of operations implemented by the serving base station 20 in the first embodiment of the method of the present disclosure, and FIG. 6 illustrates a series of time frames of the first UE 10 (having the same measurement gap configuration as described above for FIG. 3, and further illustrating a first set of Synchronization Signal Block (SSB) transmissions from the first target base station 30 and a second set of SSB transmissions from the second target base station 40).

As shown in FIG. 6, the first set of SSB transmissions from the first target base station 30 (in which transmissions from the first target base station are shown using left-to-right ascending hashed lines) have a duration of 2 ms and a periodicity of 20 ms. The first SSB transmission of the first set of SSB transmissions from the first target base station 30 occurs between 9 ms and 11 ms relative to the start of the first time frame of the first UE 10. The second SSB transmission of the first set of SSB transmissions from the first target base station 30 occurs between 29 ms and 31 ms relative to the start of the first time frame. The subsequent SSB transmissions of the first set of SSB transmissions occur at the same relative positions to subsequent time frames of the series of time frames, such that the third SSB transmission of the first set of SSB transmissions occurs between 9 ms and 11 ms after the start of the second time frame, the fourth SSB transmission of the first set of SSB transmissions occurs between 29 ms and 31 ms after the start of the second time frame, the fifth SSB transmission of the first set of SSB transmissions occurs between 9 ms and 11 ms after the start of the third time frame, and so on.

Put another way, the first set of SSB transmissions may be considered to be transmitted based on a separate series of time frames having a periodicity of 20 ms. Each time frame of this series of time frames for the first set of SSB transmissions has a transmission portion (in which the first target base station 30 transmits the SSB) which lasts for 2 ms and has zero gap offset to the start of the time frame. This series of time frames for the first set of SSB transmissions is offset from the series of time frames for the first UE's measurement gap by 9 ms.

The second set of SSB transmissions from the second target base station 30 (in which transmissions from the second target base station are shown using left-to-right descending hashed lines) also have a duration of 2 ms and a periodicity of 20 ms, but have different relative positions to the time frames of the first UE 10 compared to the first set of SSB transmissions. The first SSB transmission of the second set of SSB transmissions from the second target base station 30 occurs between 13 ms and 15 ms relative to the start of the first time frame of the first UE 10. The second SSB transmission of the first set of SSB transmissions from the first target base station 30 occurs between 33 ms and 35 ms relative to the start of the first time frame. The subsequent SSB transmissions of the second set of SSB transmissions occur at the same relative positions to subsequent time frames of the series of time frames, such that the third SSB transmission of the second set of SSB transmissions occurs between 13 ms and 15 ms after the start of the second time frame, the fourth SSB transmission of the second set of SSB transmissions occurs between 33 ms and 35 ms after the start of the second time frame, the fifth SSB transmission of the second set of SSB transmissions occurs between 13 ms and 15 ms after the start of the third time frame, and so on.

Put another way, the second set of SSB transmissions may be considered to be transmitted based on a separate series of time frames having a periodicity of 20 ms. Each time frame of this series of time frames for the second set of SSB transmissions has a transmission portion (in which the second target base station 40 transmits the SSB) which lasts for 2 ms and has zero gap offset to the start of the time frame. This series of time frames for the second set of SSB transmissions is offset from the series of time frames for the first UE's measurement gap by 13 ms.

Turning to FIG. 4, the embodiment of the method of the present disclosure will be described as it is performed in each time frame of the series of time frames. In a first iteration of S101, the measurement gap of the first time frame begins (starting 0 ms after the start of the first time frame) and the first UE 10 therefore reconfigures so as to suspend communication with the serving base station 20 and attempt communication with another base station (such as the first target base station 30 and/or second target base station 40). This reconfiguration may be to use a different frequency range and/or a different radio access technology. In S103, the measurement gap of the first time frame ends (at 6 ms after the start of the first time frame) and the first UE 10 therefore reconfigures so as to resume communication with the serving base station 20. In S105, the first UE 10 determines whether it successfully received a communication from another base station during this time frame's measurement gap. As can be seen in FIG. 6, there are no SSB transmissions of the first set or second set of SSB transmissions that are transmitted during the measurement gap of the first time frame. Accordingly, the determination of S105 of this first iteration is negative.

In S107, the first UE 10 determines whether a full cycle of time frames of the series of time frames is complete. In this context, a full cycle of time frames is complete once the first UE 10 has implemented measurement gaps across the full extent of the MGRP. In this example, the full cycle of time frames of the series of time frames is complete when the gap offset is at its maximum value. Put another way, the full cycle of time frames of the series of time frames is complete when the gap offset for a time frame plus the time shift value is greater than the MGRP. Following this first iteration, the full cycle of time frames is not yet complete and so the process loops back to S101 for a further iteration.

In the second iteration of S101, the measurement gap of the second time frame begins (starting 4 ms after the start of the second time frame) and the first UE 10 therefore reconfigures so as to suspend communication with the serving base station 20 and attempt communication with another base station (such as the first target base station 30 and/or second target base station 40). In S103, the measurement gap of the second time frame ends (at 10 ms after the start of the second time frame) and the first UE 10 therefore reconfigures so as to resume communication with the serving base station 20. In S105, the first UE 10 determines whether it successfully received a communication from another base station during this time frame's measurement gap. As can be seen in FIG. 6, the third SSB of the first set of SSB transmissions from the first target base station 30 partially falls within the second time frame's measurement gap. However, as the transmission of the third SSB of the first set of SSB transmissions is not fully received, then this third SSB is not successfully received. Furthermore, there are no other SSBs that are transmitted during the measurement gap of the second time frame. Accordingly, the determination of S105 of this second iteration is negative. The process therefore proceeds to S107 in which it is determined that the full cycle of time frames is not yet complete and so the process loops back to S101 for a further iteration.

In the third iteration of S101, the measurement gap of the third time frame begins (starting 8 ms after the start of the second time frame) and the first UE 10 therefore reconfigures so as to suspend communication with the serving base station 20 and attempt communication with another base station (such as the first target base station 30 and/or second target base station 40). In S103, the measurement gap of the third time frame ends (at 14 ms after the start of the second time frame) and the first UE 10 therefore reconfigures so as to resume communication with the serving base station 20. In S105, the first UE 10 determines whether it successfully received a communication from another base station during this time frame's measurement gap. As can be seen in FIG. 6, the fifth SSB of the first set of SSB transmissions from the first target base station 30 is wholly transmitted within the third time frame's measurement gap. Accordingly, the fifth SSB of the first set of SSB transmissions is successfully received at the first UE 10 during the measurement gap of the third time frame. Furthermore, the fifth SSB of the second set of SSB transmissions from the second target base station 40 is partially transmitted during the third time frame's measurement gap. However, as the transmission of the fifth BBS of the second set of SSB transmissions is not fully received, then this fifth SSB of the second set of SSB transmissions is not successfully received. There are no other SSBs that are transmitted during the measurement gap of the third time frame. Nonetheless, as the fifth SSB of the first set of SSB transmissions has been successfully received from the first target base station 30, then the determination of S105 of this third iteration is positive and the process proceeds to S106.

In S106, the first UE 10 stores, in memory, an identifier for the other base station detected during the measurement gap (the first target base station in this third iteration), and a value for the gap offset implemented in the time frame in which the transmission from the other base station was detected (8 ms for the third time frame). The process then loops back to S101 for a fourth iteration. The process then proceeds to S107 in which it is determined that the full cycle of time frames is not yet complete and so the process loops back to S101 for a further iteration.

In the fourth iteration of S101, the measurement gap of the fourth time frame begins (starting 12 ms after the start of the fourth time frame) and the first UE 10 therefore reconfigures so as to suspend communication with the serving base station 20 and attempt communication with another base station (such as the first target base station 30 and/or second target base station 40). In S103, the measurement gap of the fourth time frame ends (at 18 ms after the start of the fourth time frame) and the first UE 10 therefore reconfigures so as to resume communication with the serving base station 20. In S105, the first UE 10 determines whether it successfully received a communication from another base station during this time frame's measurement gap. As can be seen in FIG. 6, the seventh SSB of the second set of SSB transmissions from the second target base station 30 is wholly transmitted within the fourth time frame's measurement gap. Accordingly, the seventh SSB of the second set of SSB transmissions is successfully received at the first UE 10 during the fourth time frame. There are no other SSBs that are transmitted during the measurement gap of the fourth time frame. Nonetheless, as there is a successful reception of the seventh SSB of the second set of SSB transmissions from the second target base station 30, then the determination of S105 of this fourth iteration is positive and the process proceeds to S106 in which the first UE 10 stores, in memory, an identifier for the other base station detected during the measurement gap (the second target base station in this fourth iteration), and a value for the gap offset implemented in the time frame in which the transmission from the other base station was detected (12 ms for the fourth time frame).

The process then proceeds to S107 in which it is determined that the full cycle of time frames is not yet complete and so the process loops back to S101 for a further iteration. For the sake of brevity, no further iterations will be described. Following a negative determination in S107 (that is, there are no further time frames in the full cycle of time frames), then the process proceeds to S109.

In S109, the first UE 10 sends a measurement report message to the serving base station 20. This measurement report message includes, for each other base station detected during the measurement gaps of all time frames of the full cycle of time frames, an identifier for the other base station and a value for the gap offset implemented in the time frame in which the transmission from the other base station was detected. In this example, the first UE's measurement report message therefore identifies: 1) the first target base station 30 and the corresponding gap offset of 8 ms, and 2) the second target base station 40 and the corresponding gap offset of 12 ms.

Turning to FIG. 5, which illustrates the operations implemented by the serving base station 20 in this first embodiment, the serving base station 20 receives (in S201) the measurement report message from the first UE 10. In S203, the serving base station 20 identifies each UE of the plurality of UE that is within the coverage area of each other base station identified in the measurement report message. In this example, the serving base station 20 therefore identifies a first set of UE of the plurality of UE that are within the coverage area of the first target base station 30 (and not the coverage area of the second target base station 40), a second set of UE of the plurality of UE that are within the coverage area of the second target base station 40 (and not the coverage area of the first target base station 30), and a third set of UE of the plurality of UE that are within the overlapping coverage area of the first and second target base stations 30, 40. This may be determined by reviewing measurement report messages from each UE of the plurality of UE.

In S205, the serving base station 20 configures the measurement gap parameters for each UE of the plurality of UE based on the UE's presence within the coverage area of one or more other base stations identified in the measurement report message from the first UE 10. These configurations are to implement measurement gaps in subsequent time frames so that they only cover the transmission portion of the periodic time frames used by the one or more other base stations where the UE is within coverage. Put another way, the gap offset is configured so that the measurement gaps of subsequent time frames do not cover time periods where there are no transmissions from the one or more other base stations where the UE is within coverage. In one implementation, the gap offset is configured so that the gap offset of subsequent time frames may only take the one or more values required to receive transmissions from the one or more other base stations where the UE is within coverage. In a first example, a second UE of the plurality of UE (not shown) may be a member of the first set of the plurality of UE (such that it is within the coverage area of the first target base station 30 and not within the coverage area of the second target base station 40) and the serving base station 20 may configure its gap offset to be 8 ms. In a second example, a third UE of the plurality of UE (not shown) may be a member of the second set of the plurality of UE (such that it is within the coverage area of the second target base station 40 and not within the coverage area of the first target base station 30) and the serving base station 20 may configure its gap offset to be 12 ms. In a third example, the first UE 10 is a member of the third set of the plurality of UE (such that it is within the overlapping coverage area of the first and second target base stations 30, 40) and the serving base station 20 may configure its gap offsets to switch between 8 ms and 12 ms. These configurations assume that the second UE and third UE also use the same MGL (6 ms) and MGRP (40 ms) as the first UE 10. Otherwise, these can also be reconfigured so that the measurement gaps only cover time periods where there are transmissions from the one or more other base stations where those UE are within coverage.

Following this reconfiguration and for a predetermined time period, each UE of the plurality of UE implement measurement gaps as configured by the serving base station 20. During this predetermined time period, the gap offset may be considered static (for example, where the UE only uses a single gap offset as transmissions of the one or more other base stations where the UE is within coverage are all covered by that single gap offset), or may be variable (for example, where the UE switches between a first gap offset and a second gap offset, where the first gap offset covers transmissions of one or more other base stations where the UE is within coverage and the second gap offset covers transmissions of one or more other base stations where the UE is within coverage). Following this predetermined time period, the UE may revert back a gap offset that increments by a time shift value in each successive time frame (i.e. revert back to S101 of FIG. 3) for a full cycle of time frames so that the UE may detect a new base station that was not detected in the previous full cycle of times frames.

The above embodiment therefore implements a sliding window measurement gap so that transmissions of other base stations may be detected which would otherwise not be detected by a static measurement gap. Furthermore, once these other base stations have been detected by the sliding window measurement gap, subsequent measurement gaps may be aligned with their periodic transmissions. This reduces (or even eliminates) measurement gaps where no other base station is transmitting, improving the overall efficiency of the measurement process. Furthermore, this is achieved without enforcing time synchronization between base stations. The information contained in these transmissions from the one or more other base stations may then be used in various processes by the serving base station 20 and/or UE, such as the addition of a NR access point as a secondary access point in an Evolved-Universal Terrestrial Radio Access-New Radio Dual Connectivity (EN-DC) scenario, the addition of a NR access point as a secondary access point in a NR Dual Connectivity (NR-DC) scenario, performing a handover of the UE between a serving NR Frequency Division Duplex (FDD) access point and a target NR FDD base station, performing a handover of the UE in an EN-DC scenario, performing a handover of the UE in a NR-Evolved-Universal Terrestrial Radio Access Dual Connectivity (NE-DC) scenario, performing a handover of the UE in a Multi-Radio Access Technology Dual Connectivity (MR-DC) scenario, and/or performing a handover in a NR-DC scenario.

The above embodiment relates to a cellular telecommunications network. However, the skilled person will understand that this is non-essential and embodiments of the present disclosure may be applied to other forms of wireless telecommunications networks where a device implements a measurement gap (in which communications with an access point are temporarily suspended so that the device may communicate with another access point).

In the above embodiment, the measurement gap of a time frame changes its position in the time frame relative to a position of the measurement gap of the preceding time frame so as to detect periodic transmissions from other base stations that are transmitted at different positions of the time frame. This is achieved, in the first embodiment above, by adjusting the gap offset value of the time frame relative to that of the previous time frame. However, the skilled person will understand that other measurement gap parameters may be adjusted so as to achieve the goal of aligning the measurement gap with the transmission portion of the other base station's periodic time frame. For example, the MGRP may be configured so that the MGRP of time frame n is different to the MGRP of time frame n+1, and successful reception of a periodic transmission from another base station during one of these time frames can then be used to configure the measurement gap parameters of UE in coverage of that other base station. In such scenarios, once the UE has detected another base station, the measurement report message sent to the serving base station may indicate a value of the measurement gap parameter that is being varied between time frames.

In the above embodiment, once the gap offset for another base station is known, the gap offset for all UE within coverage of that other base station is configured so that the measurement gaps in subsequent time frames only cover time periods where there are transmissions from that other base station. However, the skilled person will also understand that this is non-essential, and that other measurement gap parameters may be configured (alternatively or additionally to the gap offset) to achieve this goal. For example, the MGL and/or MGRP may be configured. In one example, the MGL may be increased so that it covers the transmissions of a plurality of other base stations (instead of implementing a variable gap offset that switches between a first gap offset value that covers the transmission of a first other base station and a second gap offset value that covers the transmission of a second other base station).

The skilled person will understand that any combination of features is possible within the scope of the disclosure, as claimed.

1. A method of operating a User Equipment (UE) in a wireless telecommunications network, the wireless telecommunications network including a first access point, a second access point and a third access point, wherein the UE is connected to the first access point and the second access point and the third access point communicate based on periodic time frames, the method comprising:
receiving a first configuration message from the first access point, the first configuration message including measurement gap configuration data;
configuring a first measurement gap having a first set of measurement gap parameters based on the measurement gap configuration data of the first configuration message;
configuring a second measurement gap having a second set of measurement gap parameters based on the measurement gap configuration data of the first configuration message, wherein the first set of measurement gap parameters differs from the second set of measurement gap parameters such that the first measurement gap and the second measurement gap cover different portions of a periodic time frame of the second access point and different portions of a periodic time frame of the third access point;
receiving a transmission from the second access point in the first measurement gap;
receiving an identifier for the second access point;
receiving a transmission from the third access point in the second measurement gap;
receiving an identifier for the third access point; and
following receipt of the transmissions from the second access point and the third access point and of the identifiers of the second access point and the third access point, sending a report message to the first access point, the report message including a first association between the identifier for the second access point and the identifier for the first measurement gap and a second association between the identifier for the third access point and the identifier for the second measurement gap.

2. The method as claimed in claim 1, wherein the periodic time frame of the second access point includes a transmission portion and the first measurement gap covers the transmission portion of the periodic time frame of the second access point, the periodic time frame of the third access point includes a transmission portion and the second measurement gap covers the transmission portion of the periodic time frame of the third access point, and the method further comprises:
receiving a second configuration message from the first access point, the second configuration message including measurement gap configuration data;
configuring a third measurement gap having a third set of measurement gap parameters based on the measurement gap configuration data of the second configuration message, wherein the third measurement gap covers the transmission portion of the periodic time frame of the second access point; and
configuring a fourth measurement gap having a fourth set of measurement gap parameters based on the measurement gap configuration data of the second configuration message, wherein the fourth measurement gap covers the transmission portion of the periodic time frame of the third access point.

3. The method as claimed in claim 1, wherein the first set of measurement gap parameters differs from the second set of measurement gap parameters by having different gap offset values.

4. The method as claimed in claim 3, wherein the first measurement gap and the second measurement gap are of a series of measurement gaps, and each measurement gap of the series of measurement gaps occurs within a respective time frame of a series of time frames, and each time frame of the series of time frames has a predetermined length, and the method further comprises:
configuring each measurement gap of the series of measurement gaps to cover a particular portion of a respective time frame of the series of time frames, wherein a combination of all portions covered by all measurement gaps of the series of measurement gaps relative to the respective time frames covers the predetermined length.

5. A method of operating a User Equipment (UE) in a wireless telecommunications network, the wireless telecommunications network including a first access point, a second access point and a third access point, wherein the UE is in a coverage area of the first access point, a coverage area of the second access point and a coverage area of the third access point, the UE is connected to the first access point, the second access point communicates based on a periodic time frame having a transmission portion and the third access point communicates based on a periodic time frame having a transmission portion, the method comprising:
sending a report message to the first access point, the report message indicating a presence of the UE in the coverage area of the second access point and the coverage area of the second access point;
receiving a first configuration message from the first access point in response to the report message, the first configuration message including measurement gap configuration data for the second access point and measurement gap configuration data for the third access point;
configuring a first measurement gap having a first set of measurement gap parameters based on the measurement gap configuration data for the second access point of the first configuration message, wherein the measurement gap covers the transmission portion of the periodic time frame of the second access point; and
configuring a second measurement gap having a second set of measurement gap parameters based on the measurement gap configuration data for the third access point of the first configuration message, wherein the measurement gap covers the transmission portion of the periodic time frame of the third access point.

6. A method of operating a first access point in a wireless telecommunications network, the wireless telecommunications network including a first User Equipment, a second access point and a third access point, wherein the second access point communicates based on a periodic time frame having a transmission portion and the third access point communicates based on a periodic time frame having a transmission portion, the method comprising:
sending a first configuration message to the first UE, the first configuration message including measurement gap configuration data to cause the first UE to use a first measurement gap having a first set of measurement gap parameters and to cause the first UE to use a second measurement gap having a second set of measurement gap parameters, wherein the first set of measurement gap parameters differs from the second set of measurement gap parameters such that the first measurement gap and the second measurement gap cover different portions of a periodic time frame of the second access point and different portions of a periodic time frame of the third access point;
receiving a first report message from the first UE, the first report message including a first association between an identifier for the second access point and an identifier for the first measurement gap and a second association between an identifier for the third access point and an identifier for the second measurement gap; and
sending a second configuration message to the first UE, the second configuration message including measurement gap configuration data to cause the first UE to use a third measurement gap having a third set of measurement gap parameters and a fourth measurement gap having a fourth set of measurement gap parameters, wherein the third measurement gap covers the transmission portion of the periodic time frame of the second access point and the fourth measurement gap covers the transmission portion of the periodic time frame of the third access point.

7. The method as claimed in claim 6, wherein the wireless telecommunications network includes a second UE, and the method further comprises:
receiving a second report message from the second UE, the second report message from the second UE indicating a presence of the second UE in the coverage area of the second access point; and
sending a third configuration message to the second UE, the third configuration message including measurement gap configuration data to cause the second UE to use the third measurement gap having the third set of measurement gap parameters.

8. A non-transitory computer-readable storage medium comprising instructions which, when executed by a computer, cause the computer to carry out the method of claim 1.

9. A computer system comprising at least one processor and memory configured to carry out the method of claim 1.

10. A User Equipment (UE) for a wireless telecommunications network, the UE comprising a transceiver, memory and a processor configured to cooperate to carry out the method of claim 1.

11. An access point for a wireless telecommunications network, the access point comprising a transceiver, memory and a processor configured to cooperate to carry out the method of claim 6.
